(19) United States
(12) Patent Application Publication
(10) Pub. No.: US 2007/0215392 A1
(43) Pub. Date: Sep. 20, 2007

(54) Vehicle Seat Weight Sensor

(76) Inventors: Cheol-Sub Lee, Daegu (KR); Seok-IL Kim, Seoul (KR); Jang-Won Lee, Seoul (KR); You-Sik Choi, Daegu (KR); Seong-Jin Park, Seoul (KR)

Correspondence Address: BARLEY SNYDER, LLC, 1000 WESTLAKES DRIVE, SUITE 275, BERWYN, PA, 19312, US

(21) Appl. No.: 11/687,418

(22) Filed: Mar. 16, 2007

(30) Foreign Application Priority Data
Mar. 17, 2006 (KR) 10-2006-0024978

(51) Int. Cl. G01G 19/52; G01L 1/22

(52) U.S. Cl. 177/144; 73/862.474

(57) ABSTRACT

A seat weight sensor having a support frame, a fixed rail at least partially disposed above the support frame, an elastic deformation unit connected between the support frame and the fixed rail for supporting the fixed rail, and a strain gauge associated with the elastic deformation unit is disclosed.

### CROSS-REFERENCE TO RELATED APPLICATIONS

This application claims the benefit of the filing date under 35 U.S.C. § 119(a)-(d) of Korean patent application document 10-2006-0024978 of Mar. 17, 2006.

### FIELD OF THE INVENTION

The present invention relates to a seat weight sensor, and more particularly, to a seat weight sensor with a simple structure.

### BACKGROUND

Generally, vehicle seat weight sensors refer to devices which are installed between the lower surface of a seat in a vehicle and the bottom of the inside of the vehicle and which are used to sense whether or not a person is sitting on the seat based on the load applied.

FIG. 13 is an orthogonal sectional view of a conventional vehicle seat weight sensor.

As shown in FIG. 13, the conventional vehicle seat weight sensor includes a seat pan 100 of a vehicle seat, a movable rail 200 provided below the seat pan 100, a case 300 interposed between the seat pan 100 and the movable rail 200 and provided with blades 301 protruded downwardly from both sides thereof, a strain gauge 400 horizontally installed in the case 300 for measuring the strain of the case 300 according to the load, and a fixing member 500 passing through the case 300 and attached to the seat pan 100 so as to fix the case 300.

In the above conventional weight sensor, when a passenger sits on the vehicle seat, the case 300 provided between the seat pan 100 and the movable rail 200 is deformed by the load applied thereto under the condition that the case 300 is supported by the blades 301, and then the strain gauge 400 installed in the case 300 is deformed to measure the load.

The load measured by the strain gauges 400 is outputted to control equipment, which is installed in the vehicle and connected to the strain gauge 400 by a lead wire through electrical signals. The control equipment determines whether a person is sitting on the seat through load data inputted from the strain gauge 400. Based on that determination, the control equipment enables and/or disables the operation of air bags associated with the seat for use in an emergency, such as vehicle collision.

However, the above-described conventional vehicle seat weight sensor has problems, as follows.

The case 300 is formed on the fixing member 500 by insert molding under the condition that the strain gauge 400 is installed in the case, and thus has a complicated structure and is easily damaged when it is repeatedly used for a long period of time, remarkably shortening the life span of the case 300.

The case 300, which is formed on the fixing member 500 by insert molding, is not easily deformed by the load applied thereto. Thus, the measuring sensitivity of the strain gauge 400 is lowered due to the stiffness of the case 300.

It is difficult to install the lead wire of the strain gauge 400 connected to the control equipment, thus requiring a long time to connect the strain gauge 400 to the control equipment. Further, the connection between the strain gauge 400 and the control equipment is not stable.

The strain gauge 400 outputs the measured data in weak electrical signals, and the electrical signals can be distorted or disappear due to an external magnetic body or an electric impulse while transmitting the electrical signals to the control equipment of the vehicle.

### SUMMARY OF THE INVENTION

The present invention relates to a seat weight sensor having a support frame, a fixed rail at least partially disposed above the support frame, an elastic deformation unit connected between the support frame and the fixed rail for supporting the fixed rail, and a strain gauge associated with the elastic deformation unit.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded oblique view of a vehicle seat weight sensor in accordance with a first embodiment of the present invention;

FIG. 2 is an orthogonal sectional view of the vehicle seat weight sensor, in an assembled state, in accordance with the first embodiment of the present invention;

FIG. 3 is an orthogonal sectional view of a vehicle seat weight sensor in accordance with a second embodiment of the present invention;

FIG. 4 is an orthogonal sectional view of a vehicle seat weight sensor in accordance with a third embodiment of the present invention;

FIG. 5 is an orthogonal sectional view of a vehicle seat weight sensor in accordance with a fourth embodiment of the present invention;

FIG. 6 is an orthogonal sectional view of a vehicle seat weight sensor in accordance with a fifth embodiment of the present invention;

FIG. 7 is a side sectional view of the vehicle seat weight sensor of FIG. 6;

FIG. 8 is an orthogonal sectional view of a vehicle seat weight sensor in accordance with a sixth embodiment of the present invention;

FIG. 9 is a side sectional view of the vehicle seat weight sensor of FIG. 8;

FIG. 10 is an orthogonal sectional view of a vehicle seat weight sensor in accordance with a seventh embodiment of the present invention;

FIG. 11 is an orthogonal sectional view of a vehicle seat weight sensor in accordance with an eighth embodiment of the present invention;

FIG. 12 is an orthogonal sectional view of a vehicle seat weight sensor in accordance with a ninth embodiment of the present invention; and

FIG. 13 is an orthogonal sectional view of a conventional vehicle seat weight sensor.

### DESCRIPTION OF THE PREFERRED EMBODIMENTS

Now, preferred embodiments of the present invention will be described in detail with reference to the annexed drawings.

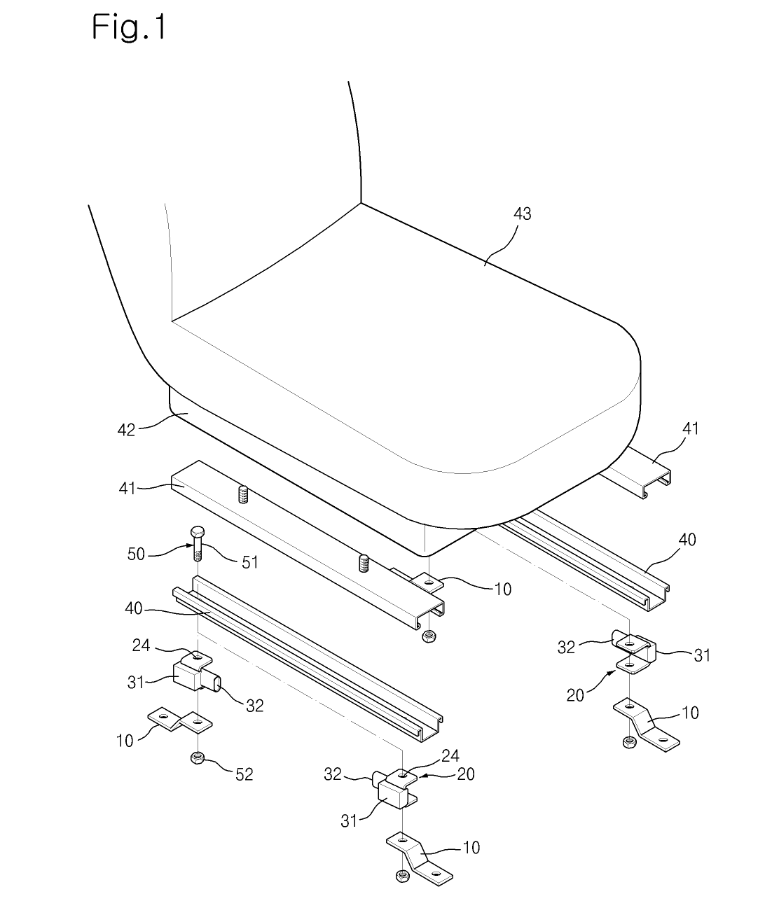

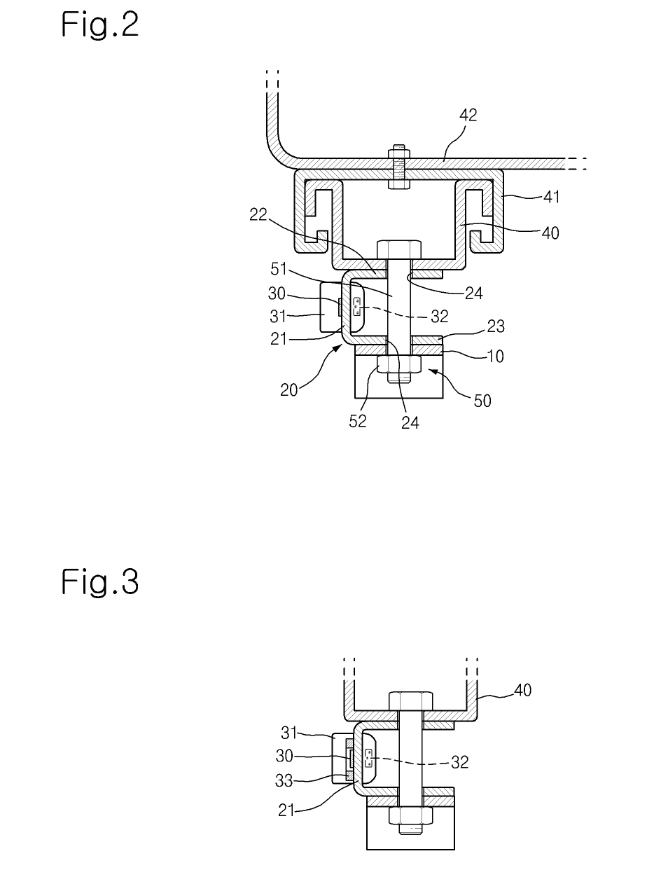

FIG. 1 is an exploded oblique view of a vehicle seat weight sensor in accordance with a first embodiment of the present invention, and FIG. 2 is an orthogonal sectional view of the vehicle seat weight sensor, in an assembled state, in accordance with the first embodiment of the present invention.

As shown in FIGS. 1 and 2, the vehicle seat weight sensor in accordance with the first embodiment comprises support frames 10 attached to the bottom of the inside of a vehicle, elastic deformation units 20 respectively disposed on the upper surfaces of the support frames 10, strain gauges 30 respectively attached to the elastic deformation units 20, fixed rails 40 respectively disposed on the upper surfaces of the elastic deformation units 20, and fixing units 50 respectively fixing the elastic deformation units 20 and installed between the support frames 10 and the fixed rails 40.

Four support frames 10 provided in pairs are attached to the bottom of the inside of the vehicle such that they are spaced from each other at regular intervals, and serve to support a seat 43 installed in the vehicle and simultaneously to support the lower surfaces of the elastic deformation units 20 so that the elastic deformation units 20 can be successfully deformed by the load, which is applied downwardly.

Each of the elastic deformation units 20 includes a vertical deformation piece 21 disposed between the support frame 10 and the fixed rail 40, an upper bending portion 22 formed by horizontally bending the upper end of the vertical deformation piece 21, a lower bending portion 23 formed by horizontally bending the lower end of the vertical deformation piece 21, and through holes 24 formed through the upper bending portion 22 and the lower bending portion 23.

The above-described elastic deformation unit 20 is disposed such that the lower bending portion 23 at the lower end of the vertical deformation piece 21 contacts the upper surface of the support frame 10 and the upper bending portion 22 at the upper end of the vertical deformation piece 21 contacts the lower surface of the fixed rail 40. Thereby, the upper bending portion 22 is pressurized by the load, which is applied downwardly from the fixed rail 40, under the condition that the lower bending portion 23 is supported by the support frame 10, and thus the vertical deformation piece 21 in a vertical state is bent and deformed.

On the other hand, when the load applied to the upper bending portion 22 is released, the vertical deformation piece 21 is elastically restored to its initial state.

The vertical deformation piece 21 may be made of a metal plate, and the upper and lower ends of the vertical deformation piece 21 are bent so as to form the upper and lower bending portions 22 and 23. That is, the elastic deformation unit 20 has a simple and stable structure, in which the deformation of the vertical deformation piece 21 due to the load and the resilience of the vertical deformation piece 21 due to the release of the load are stably performed repeatedly for a long period of time. Thereby, the weight sensor of the present invention is simply manufactured and assembled, and has a long life span.

The through holes 24 are vertically formed through the upper bending portion 22 and the lower bending portion 23, which are formed by horizontally bending the upper and lower ends of the vertical deformation piece 21. The fixing unit 50 installed between the support frame 10 and the fixed rail 40 is inserted into the through holes 24, thus successfully fixing the vertical deformation piece 21.

The vertical deformation piece 21 may have a thickness of 2-4 ÿ. When the thickness of the vertical deformation piece 21 made of a metal plate is smaller than 2 ÿ, the vertical deformation piece 21 may not be successfully restored to its initial state when the load is released after the vertical deformation piece 21 is deformed due to the load, thus having a shortened life span. On the other hand, when the thickness of the vertical deformation piece 21 is larger than 4 ÿ, the vertical deformation piece 21 is not successfully deformed due to the load, thus having a poor measuring sensitivity.

The strain gauge 30 is attached to the outer surface of the vertical deformation piece 21, and serves to measure the strain of vertical deformation piece 21 due to the load and simultaneously output the measured data in the form of electrical signals to control equipment of the vehicle.

Each of the strain gauges 30 includes a connection body 31 formed on the outer surface of the vertical deformation piece 21 by insert molding using molten synthetic resin so as to surround the outer surface of the vertical deformation piece 21, and a connection header 32 formed integrally with the outer surface of the connection body 31 by insert molding under the condition that a plurality of pins is connected to the strain gauge 30 by a lead wire and is exposed to the inner surface of the connection header 32.

The connection body 31 is formed on the outer surface of the vertical deformation piece 21 by insert molding using molten synthetic resin under the condition that a plurality of pins is connected to the strain gauge 30 by a lead wire and is exposed to a portion on which the connection header 32 is formed, thus being easily formed with a simple structure and serving to protect the strain gauge 30 and facilitate the formation of the connection header 32. Further, the connection body 31 serves to assure the electrical connection between the strain gauge 30 and the connection pins provided in the connection header 32 for a long period of time.

The connection pins electrically connected to the strain gauge 30 by the lead wire are exposed to the opened inner surface of the connection header 32. When a plug of the control equipment is inserted into the connection header 32, terminals of the plug are easily connected to the connection pins exposed to the opened inner surface of the connection header 32. That is, the connection header 32 allows the electrical connection between the strain gauge 30 and the control equipment of the vehicle to be simply and stably achieved.

The fixed rails 40 are slidably connected to movable rails 41 attached to the seat pan 42 of the seat 43 under the condition that the fixed rails 40 contact the upper surfaces of the upper bending portions 22. The fixed rails 40 serve to transmit the load, applied when a passenger sits on the seat 43, to the upper bending portions 22, and simultaneously to support the fixing units 50, the ends of which are attached to the lower surfaces of the fixed rails 40.

The fixing units 50 are slidably inserted into the through holes 24, and serve to fix the elastic deformation units 20 in a deformable state and simultaneously to fix the fixed rails 40 to the support frames 10. Each of the fixing units 50 includes a fixing bolt 51, which passes through the support frame 10 via the through holes 24 and is caught on the upper surface of the fixed rail 40, and a fixing nut 52, which contacts the lower surface of the support frame 10 and is connected to the lower end of the fixing bolt 51.

The above-described fixing units 50 stably guide the elastic restoration of the vertical deformation pieces 21 by the support of the fixing bolts 51 of the fixing units 50, and facilitate the installation and fixation of the vertical deformation pieces 21 through fixing parts, which are generally used, for attaching the fixed rails 40 to the support frames 10. Instead of the fixing bolt 51 and the fixing nut 52, the fixing unit 50 may use various fixing parts, such as a pin, a shaft, or a rivet, which can fix the vertical deformation piece 21 in a deformable state.

FIG. 3 is an orthogonal sectional view of a vehicle seat weight sensor in accordance with a second embodiment of the present invention.

As shown in FIG. 3, in the vehicle seat weight sensor in accordance with the second embodiment, the strain gauge 30 further includes an amplifier circuit 33, which is installed in the connection body 31 under the condition that it is connected between the connection body 31 and the connection header 32 through electrical signals, and is made of a printed circuit board so as to amplify the electrical signals.

The amplifier circuit 33 serves to measure the deformation state of the vertical deformation piece 21 and amplify an electrical signal outputted from the strain gauge 30 when the load is applied downwardly from the fixed rail 40 and deforms the vertical deformation piece 21.

As described above, the amplifier circuit 33 amplifies the electrical signal outputted from the strain gauge 30. The amplified electrical signal is outputted to the control equipment of the vehicle connected to the strain gauge 30 by the connection header 32. Further, it is possible to prevent the distortion or the disappearance of the electrical signal generated by other electronic products in the vehicle when the electrical signal is transmitted to the control equipment.

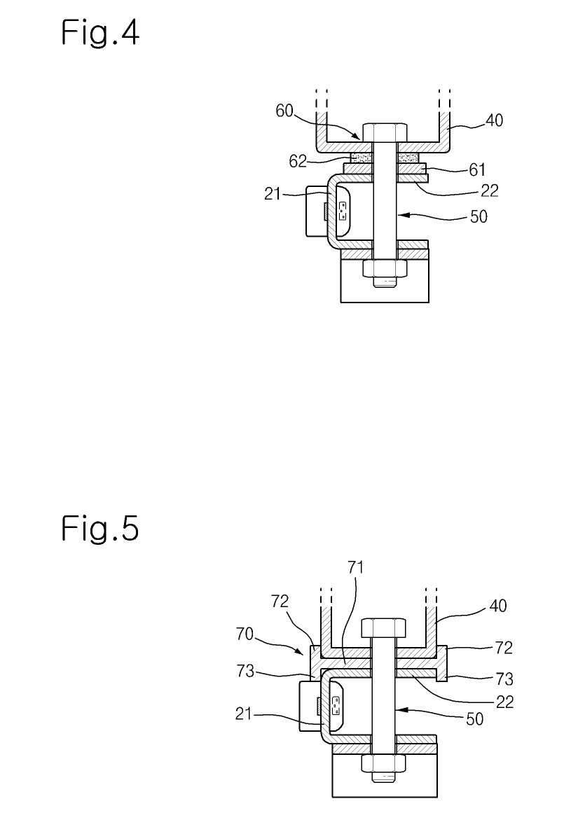

FIG. 4 is an orthogonal sectional view of a vehicle seat weight sensor in accordance with a third embodiment of the present invention.

As shown in FIG. 4, the vehicle seat weight sensor in accordance with the third embodiment further comprises, load concentration units 60, each of which is installed between the fixed rail 40 and the upper bending portion 22 for concentrating the load applied downwardly from the fixed rail 40 on the upper bending portion 22.

The load concentration unit 60 concentrates the load applied from the fixed rail 40 on a designated region of the upper bending portion 22, and the vertical part of the vertical deformation piece 21 is deformed at a constant rate at all times according to increases and decreases in the load. Thereby, precision in measuring the strain of the vertical deformation piece 21 is improved.

The above load concentration unit 60 includes a load concentration plate 61, which is provided between the lower surface of the fixed rail 40 and the upper surface of the upper bending portion 22, and, through which the fixing unit 50 passes, and a plate-shaped damper 62, which is provided between the upper surface of the load concentration plate 61 and the lower surface of the fixed rail 40 so as to fix the load concentration plate 61.

The load concentration plate 61 contacts a designated region of the lower surface of the fixed rail 40 and a designated region of the upper surface of the upper bending portion 22, and serves to concentrate the load applied downwardly from the fixed rail 40 on the designated region of the upper surface of the upper bending portion 22.

The plate-shaped damper 62 may be made of synthetic rubber, and is disposed between the lower surface of the fixed rail 40 and the upper surface of the upper bending portion 22. The plate-shaped damper 62 is compressively deformed when the vertical deformation piece 21 is fixed by the fixing unit 50, and serves to firmly fix the load concentration plate 61 between the fixed rail 40 and the upper bending portion 22.

FIG. 5 is an orthogonal sectional view of a vehicle seat weight sensor in accordance with a fourth embodiment of the present invention.

As shown in FIG. 5, the vehicle seat weight sensor in accordance with the fourth embodiment further comprises upper anti-rotation units 70, each of which is installed between the fixed rail 40 and the upper bending portion 22. The upper anti-rotation unit 70 prevents the rotation of the vertical deformation piece 21 so as to fix the vertical deformation piece 21 to a constant position at all times.

The upper anti-rotation unit 70 includes an insertion plate 71, which is interposed between the lower surface of the fixed rail 40 and the upper surface of the upper bending portion 22, and through which the fixing unit 50 passes. Upper protrusions 72 protrude upwardly from both side surfaces of the insertion plate 71 so as to contact both side surfaces of the fixed rail 40. Lower protrusions 73 protrude downwardly from both side surfaces of the insertion plate 71 so as to contact both side surfaces of the upper bending portion 22.

In the above upper anti-rotation unit 70, the insertion plate 71 is interposed between the fixed rail 40 and the upper bending portion 22 such that the upper protrusions 72 support both side surfaces of the fixed rail 40 and the lower protrusions 73 support both side surfaces of the upper bending portion 22. Thus, although external force is applied to the upper elastic deformation unit 20, the vertical deformation piece 21 is not rotated but is fixed to a designated position.

The insertion plate 71 contacts the lower surface of the fixed rail 40 and the upper surface of the upper bending portion 22, and thus also serves to concentrate the load applied downwardly from the fixed rail 40 on the upper bending portion 22.

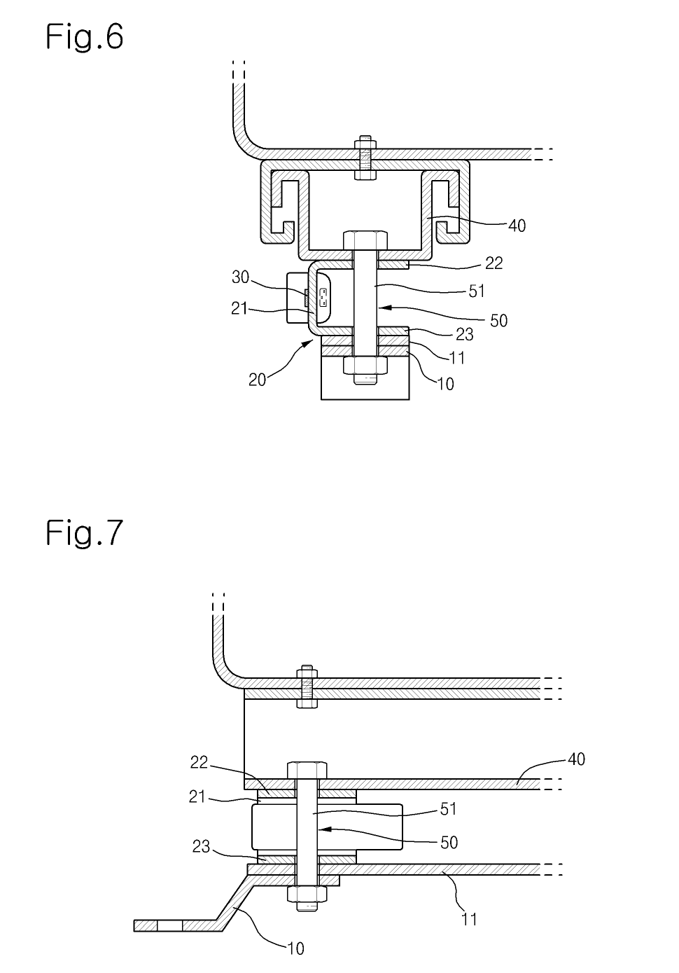

FIG. 6 is an orthogonal sectional view of a vehicle seat weight sensor in accordance with a fifth embodiment of the present invention, and FIG. 7 is a side sectional view of the vehicle seat weight sensor of FIG. 6.

As shown in FIGS. 6 and 7, the vehicle seat weight sensor in accordance with the fifth embodiment further comprises subsidiary support plates 11, each of which is installed between the upper surface of the support frame 10 and the lower surface of the lower bending portion 23 under the condition that the fixing unit 50 passes through the subsidiary support plate 11.

The subsidiary support plate 11 is provided between a pair of the support frames 10. The subsidiary support plate 11 is interposed between the upper surface of the support frame 10 and the lower surfaces of the lower bending portion 23 under the condition that the fixing unit 50 passes through the subsidiary support plate 11, and serves to support the lower surface of the lower bending portion 23.

When the upper bending portion 22 is pressed by the load applied downwardly from the fixed rail 40 and thus the vertical deformation piece 21 is deformed, the lower bending portion 23 is stably supported by the subsidiary support plate 11. Thereby, it is possible to successfully measure the strain of the vertical deformation piece 21 using the stain gauge 30 as well as to easily install the elastic deformation unit 20.

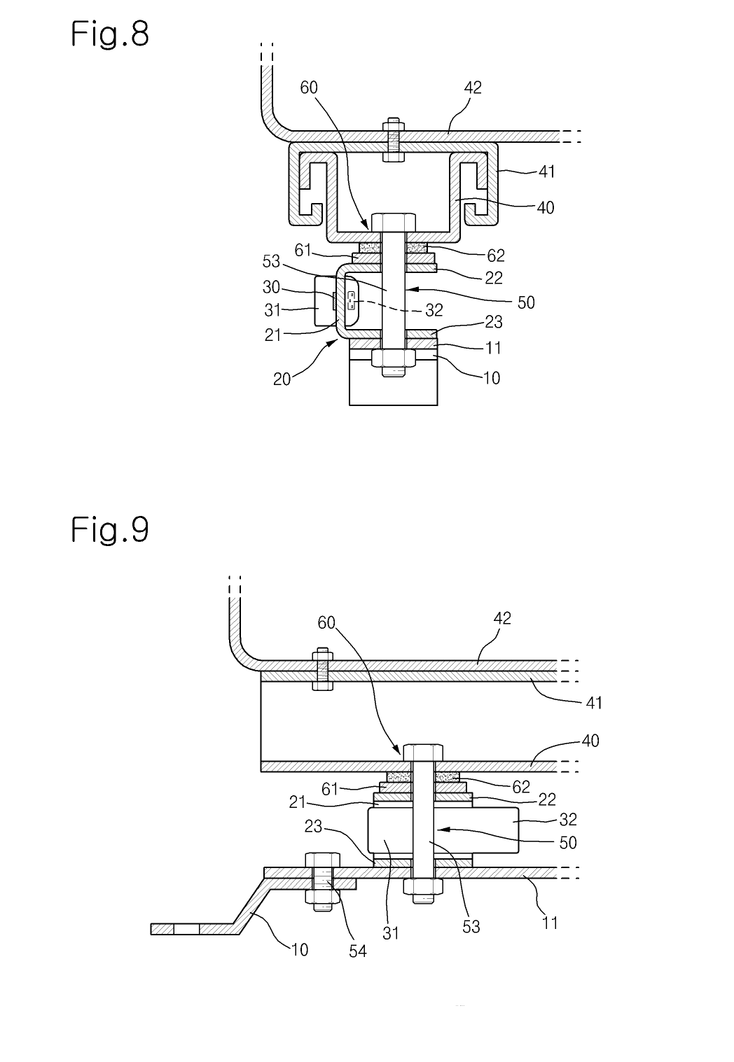

FIG. 8 is an orthogonal sectional view of a vehicle seat weight sensor in accordance with a sixth embodiment of the present invention, and FIG. 9 is a side sectional view of the vehicle seat weight sensor of FIG. 8.

As shown in FIGS. 8 and 9, the vehicle seat weight sensor in accordance with the sixth embodiment comprises support frames 10 attached to the bottom of the inside of a vehicle, subsidiary support plates 11 respectively attached to the upper surfaces of the support frames 10, elastic deformation units 20 respectively disposed on the upper surfaces of the subsidiary support plates 11, strain gauges 30 respectively attached to the outer surfaces of the elastic deformation units 20, fixed rails 40 respectively disposed on the upper surfaces of the elastic deformation units 20, and fixing units 50 respectively fixing the subsidiary support plates 11 to the fixed rails 40 and fixing the subsidiary support plates 11 to the support frames 10 under the condition that the fixing units 50 pass through the elastic deformation units 20.

Four support frames 10 provided in pairs are attached to the bottom of the inside of the vehicle such that they are spaced from each other at regular intervals, and serve to support a seat installed in the vehicle.

Each of the subsidiary support plates 11 is provided between a pair of the support frames 10 such that both ends of each of the subsidiary support plates 11 are attached to the corresponding support frames 10 by second fixing members 54 of the fixing units 50. The subsidiary support plate 11 supports the lower surfaces of the elastic deformation units 20 so as to allow the elastic deformation units 20 to be successfully deformed by the load and to allow the positions of vertical deformation pieces 21 of the elastic deformation units 20 to be easily modified.

A lower bending portion 23 of the elastic deformation unit 20 contacts the upper surface of the subsidiary support plate 11 and an upper bending portion 22 of the elastic deformation unit 20 contacts lower surface of the fixed rail 40 under the condition that a first fixing member 53 of the fixing unit 50 is inserted into through holes 24 formed through the upper and lower bending portions 22 and 23. Thereby, the upper bending portion 22 is pressurized by the load, which is applied downwardly from the fixed rail 40, under the condition that the lower bending portion 23 is supported by the subsidiary support plate 11. Accordingly, the vertical deformation piece 21 in a vertical state (which is formed between the upper and lower bending portions 22 and 23 integrally with the upper and lower bending portions 22 and 23) is bent and deformed.

On the other hand, when the load applied to the upper bending portion 22 is released, the deformed portion of the vertical deformation piece 21 is elastically restored to its initial state.

The vertical deformation piece 21, which is separated from the support frame 10, is not interfered with by the support frame 10, thus being more simply installed.

As described above, the elastic deformation unit 20 has a simple and stable structure obtained by bending a metal plate being substantially C-shaped, in which deformation of the vertical deformation piece 21 due to the load and the resilience of the vertical deformation piece 21 due to release of the load are stably performed repeatedly for a long period of time. Thereby, the elastic deformation unit 20 is simply manufactured and assembled, and has a long life span.

The fixing unit 50 is slidably inserted into the through holes 24, and thus serves to fix the fixing rail 40 to the subsidiary support plate 11 and simultaneously to fix the subsidiary support plate 11 to the support frame 10. The fixing unit 50 includes the first fixing member 53 slidably inserted into the through holes 24 for fixing the elastic deformation unit 20 in a deformable state between the subsidiary support plate 11 and the fixed rail 40, and the second fixing member 54 fixing one end of the subsidiary support plate 11 to the upper surface of the support frame 10.

The vehicle seat weight sensor in accordance with this embodiment further comprises load concentration units 60, each of which serves to concentrate the load applied downwardly from the fixed rail 40 on the upper bending portion 22. The load concentration unit 60 includes a load concentration plate 61, which is provided between the lower surface of the fixed rail 40 and the upper surface of the upper bending portion 22, and, through which the fixing unit 50 passes, and a plate-shaped damper 62, which is provided between the upper surface of the load concentration plate 61 and the lower surface of the fixed rail 40 so as to fix the load concentration plate 61.

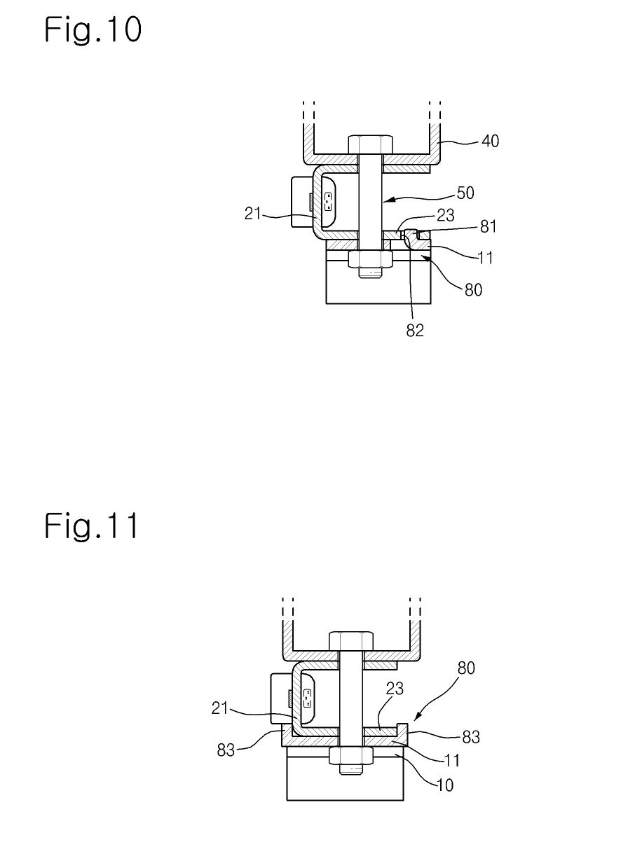

FIG. 10 is an orthogonal sectional view of a vehicle seat weight sensor in accordance with a seventh embodiment of the present invention.

As shown in FIG. 10, the vehicle seat weight sensor in accordance with the seventh embodiment further comprises lower anti-rotation units 80, each of which is installed under the subsidiary support plate 11 and the lower bending portion 23 so as to prevent the rotation of the vertical deformation piece 21. The lower anti-rotation unit 80 prevents the rotation of the vertical deformation piece 21 so as to fix the vertical deformation piece 21 to a constant position at all times.

The lower anti-rotation unit 80 includes a bent fixing protrusion 81 obtained by cutting the subsidiary support plate 11 and bending the cut portion of the subsidiary support plate 11 upwardly, and an insertion hole 82 formed through the lower bending portion 23 so that the bent fixing protrusion 81 is inserted into the insertion hole 82.

The lower anti-rotation unit 80 prevents the rotation of the vertical deformation piece 21 centered on the fixing unit 50 by inserting the bent fixing protrusion 81 into the insertion hole 82.

FIG. 11 is an orthogonal sectional view of a vehicle seat weight sensor in accordance with an eighth embodiment of the present invention.

As shown in FIG. 11, in the vehicle seat weight sensor in accordance with the eighth embodiment, the lower anti-rotation unit 80 includes a pair of protrusions 83 protruding upwardly from both side surfaces of the subsidiary support plate 11 so as to contact both side surfaces of the lower bending portion 23.

The protrusions 83 may be obtained by bending both side ends of the subsidiary support plate 11 upwardly. The protrusions 83 contact both side surfaces of the lower bending portion 23, and serve to prevent the rotation of the vertical deformation piece 21.

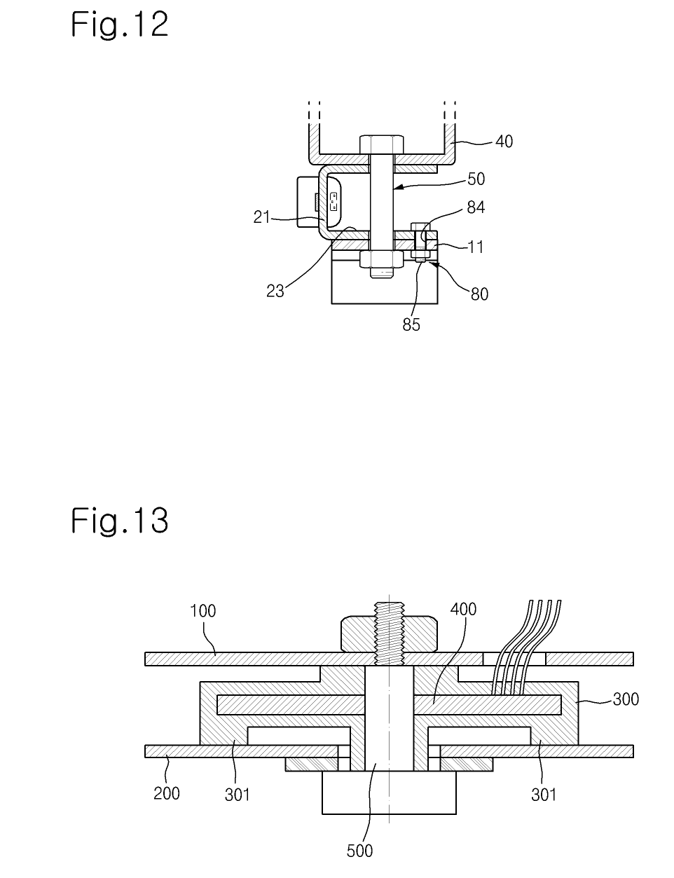

FIG. 12 is an orthogonal sectional view of a vehicle seat weight sensor in accordance with a ninth embodiment of the present invention.

As shown in FIG. 12, in the vehicle seat weight sensor in accordance with the ninth embodiment, the lower anti-rotation unit 80 includes vertical through holes 84 formed through the lower bending portion 23 and the subsidiary support plate 11, and a fixture 85 connected to the vertical through holes 84 so as to the fix the lower bending portion 23 to the subsidiary support plate 11.

The fixture 85 of the lower anti-rotation unit 80 connects the lower bending portion 23 to the subsidiary support plate 11 through the vertical through holes 84, thus firmly fixing the lower bending portion 23 to the subsidiary support plate 11. Thereby, it is possible to prevent the rotation of the vertical deformation piece 21 centering on the fixture 50.

The fixture 85 may have a bolt connection structure, as described in FIG. 12, or use various fixing parts, such as a rivet, if necessary.

As apparent from the above description, the present invention provides a vehicle seat weight sensor with a simple structure, which is repeatedly usable for a long period of time, remarkably increases measuring sensitivity, and precisely and stably measures the load, is simply manufactured and installed, has lengthened life span, and improves precision in measurement.

The vehicle seat weight sensor is stably and simply installed using subsidiary support plates 11, thus being simply installed and assembled and allowing positions of measuring units to be changed based on a worker's selection.

The vehicle seat weight sensor facilitates the connection between the measuring units and control equipment, thus easily and rapidly achieving the connection between the measuring units and the control equipment and assuring reliability of the connection.

The vehicle seat weight sensor outputs electrical signals of the strain gauges in an amplified state to prevent the electrical signals from being distorted or disappearing during transmitting the electrical signals to the control equipment, thus allowing measured data to be stably and precisely outputted and improving precision in measurement.

The vehicle seat weight sensor prevents the measuring units, such as strain gauges, from rotating so as to be fixed to a regular position at all times, thus preventing the generation of errors in measurement due to the rotation of the strain gauges and stably and precisely measuring the load.

The vehicle seat weight sensor concentrates the load applied to a vehicle seat so as to increase in measuring sensitivity and precisely measure the load, thus preventing the generation of errors in measurement due to the decentralization of the load and improving precision in measurement.

Although the preferred embodiments of the present invention have been disclosed for illustrative purposes, those skilled in the art will appreciate that various modifications, additions, and substitutions are possible, without departing from the scope and spirit of the invention as disclosed in the accompanying claims.

What is claimed is:

1. A seat weight sensor, comprising:
a support frame;
a fixed rail at least partially disposed above the support frame;
an elastic deformation unit connected between the support frame and the fixed rail for supporting the fixed rail; and
a strain gauge associated with the elastic deformation unit.

2. The seat weight sensor according to claim 1, further comprising:
a fixing unit received through the elastic deformation unit, the fixing unit configured to fix the elastic deformation unit with respect to the support frame and the fixed rail while allowing deformation of the elastic deformation unit.

3. The seat weight sensor according to claim 1, wherein the elastic deformation unit is substantially C-shaped.

4. The seat weight sensor according to claim 1, the elastic deformation unit comprising:
an upper bending portion;
a lower bending portion; and
a vertical deformation piece joining the upper bending portion to the lower bending portion;
wherein the strain gauge measures strains of the vertical deformation piece.

5. The seat weight sensor according to claim 4, further comprising:
a fixing unit received within a through hole of the upper bending portion and a through hole of the lower bending portion, the fixing unit configured to fix the elastic deformation unit with respect to the support frame and the fixed rail while allowing deformation of the elastic deformation unit.

6. The seat weight sensor according to claim 5, further comprising:
a subsidiary support plate at least partially disposed between the support frame and the fixed rail.

7. The seat weight sensor according to claim 6, the fixing unit comprising:
a first fixing member configured to connect the elastic deformation unit between the fixed rail and the subsidiary support plate; and
a second fixing member configured to connect the subsidiary support plate to the support frame.

8. The seat weight sensor according to claim 5, the strain gauge comprising:
a connection body formed on an outer surface of the vertical deformation piece; and
a connection header formed on an outer surface of the connection body and electrically connected to the connection body.

9. The seat weight sensor according to claim 8, wherein the connection body is formed by insert molding.

10. The seat weight sensor according to claim 5, the strain gauge comprising:
an amplifier circuit configured to amplify an electrical signal of the strain gauge.

11. The seat weight sensor according to claim 5, the fixing unit comprising:
a fixing bolt contacting an upper surface of the fixed rail; and
a fixing nut connected to the fixing bolt and contacting a lower surface of the support frame.

12. The seat weight sensor according to claim 5, further comprising:
an upper anti-rotation unit at least partially disposed between the fixed rail and the upper bending portion and configured to prevent rotation of the vertical deformation piece.

13. The seat weight sensor according to claim 12, the upper anti-rotation unit comprising:
an insertion plate disposed between the upper bending portion and the fixed rail;
an upper protrusion protruding upward from the insertion plate and configured to contact a side surface of the fixed rail; and
a lower protrusion protruding downward from the insertion plate and configured to contact a side surface of the upper bending portion.

14. The seat weight sensor according to claim 5, further comprising:
a lower anti-rotation unit configured to contact the lower bending portion and configured to prevent rotation of the vertical deformation piece.

15. The seat weight sensor according to claim 14, further comprising:
a subsidiary support plate at least partially disposed between the support frame and the fixed rail;
a vertical through hole formed in each of the lower bending portion and the subsidiary support plate; and
a fixture received with the vertical through holes of the lower bending portion and the subsidiary support plate for fixing the lower bending portion to the subsidiary support plate.

16. The seat weight sensor according to claim 5, further comprising:
a lower anti-rotation unit at least partially disposed between the support frame and the lower bending portion and configured to prevent rotation of the vertical deformation piece.

17. The seat weight sensor according to claim 16, the lower anti-rotation unit comprising:
a bent fixing protrusion formed in the subsidiary support plate and configured for insertion into an insertion hole formed in the lower bending portion.

18. The seat weight sensor according to claim 16, the lower anti-rotation unit comprising:
a protrusion protruding upward from the subsidiary support plate and configured to contact a side surface of the lower bending portion.

19. The seat weight sensor according to claim 5, further comprising:
a load concentration unit disposed between the fixed rail and the upper bending portion.

20. The seat weight sensor according to claim 19, the load concentration unit comprising:
a load concentration plate configured to allow passage of the fixing unit therethrough.

21. The seat weight sensor according to claim 5, wherein the vertical deformation piece comprises a thickness of about 2-4 millimeters.
